(19) United States
(12) Patent Application Publication
(10) Pub. No.: US 2016/0085120 A1
(43) Pub. Date: Mar. 24, 2016

(54) DISPLAY PANEL AND DISPLAY DEVICE

(71) Applicants: Boe Technology Group Co., Ltd., Beijing (CN); Heifi Xinsheng Optoelectronics Technology Co., Ltd., Anhui (CN)

(72) Inventor: Jun Xu, Beijing (CN)

(21) Appl. No.: 14/741,772

(22) Filed: Jun. 17, 2015

(30) Foreign Application Priority Data
Sep. 23, 2014 (CN) 201410490296.X

(51) Int. Cl. G02F 1/1343; G02F 1/1335

(52) U.S. Cl. CPC G02F 1/134309; G02F 1/133514; G02F 1/13439; G02F 2001/134345

(57) ABSTRACT

This disclosure relates to a display panel and a display device, said display panel comprising an array substrate, a color film substrate and a first liquid crystal layer disposed between the array substrate and the color film substrate, said display panel further comprising an electro-optic effect layer and an electrode layer disposed on one side or on both sides of the electro-optic effect layer; said electrode layer is used to generate an electric field in said electro-optic effect layer; said electro-optic effect layer is disposed on an outer side of the array substrate or on an outer side of the color film substrate, for causing birefringence of light rays to occur under the effect of said electric field when they pass through said electro-optic effect layer. Said display panel is capable of flexibly adjusting the color gamut displayed by the display panel within a larger range and has a lower cost.

### RELATED APPLICATIONS

The present application claims the benefit of Chinese Patent Application No. 201410490296.X, filed Sep. 23, 2014, the entire disclosure of which is incorporated herein by reference.

### TECHNICAL FIELD

This disclosure relates to the technical field of liquid crystal display, and specifically to a display panel and a display device.

### BACKGROUND ART

Color gamut is the sum total of all possible colors generated by a technical system. In a display device, color gamut is one of the important indexes for evaluating the display quality. With the development of techniques and the constant changes in the need of use, people now require display devices to have not only larger color gamut, but also different color gamuts in different display situations.

For an existing display device, it is generally enabled to have different color gamuts in different display situations by using a method as follows, i.e., installing in the display device a plurality of backlight sources which emit light rays with different color gamuts respectively (that is, the proportions of the stimulus values of the three primary colors in the light rays emitted from the backlight sources are different). Specifically, when the display device displays an image, by switching to a different backlight source, the backlight source with corresponding color gamut is made to provide backlights to the display panel such that the image displayed by the display device has corresponding color gamut.

In the above display device, backlight sources are added therein so as to enable the display device to have different color gamuts in different display situations, which obviously increases the cost of manufacturing the display device; moreover, due to the restrictions of volume and weight of the display device, a number of the backlight sources within the display device cannot be augmented without limit, and as a result the color gamut of the display device can only be adjusted among several color gamuts (a number of the color gamuts is equivalent to a number of the backlight sources), i.e., the color gamut of the display device has a small range of adjustment.

### SUMMARY

The objective of this disclosure is to at least solve one of the technical problems existing in the prior art by putting forward a display panel and a display device, which display panel is capable of flexibly adjusting the color gamut it displays within a larger range and has a lower cost.

To achieve the objective of this disclosure, a display panel is provided, comprising an array substrate, a color film substrate and a first liquid crystal layer disposed between the array substrate and the color film substrate, and further comprising an electro-optic effect layer and an electrode layer disposed on one side or on both sides of the electro-optic effect layer; said electrode layer is used to generate an electric field in said electro-optic effect layer; said electro-optic effect layer is disposed on an outer side of the array substrate or on an outer side of the color film substrate, for causing the birefringence of light rays to occur under the effect of said electric field when they pass through said electro-optic effect layer.

Optionally, said electro-optic effect layer is a film layer made of a crystal material having Kerr effect.

Optionally, the crystal material having Kerr effect includes at least one of nitrobenzene and nitrotoluene.

Optionally, said display panel further comprises a first substrate disposed at an outer side of the array substrate or on an outer side of the color film substrate, and said electro-optic effect layer is a second liquid crystal layer disposed between the array substrate and a first substrate disposed at an outer side of the array substrate, or between the color film substrate and a first substrate disposed on an outer side of the color film substrate.

Optionally, said electrode layer generates a plurality of electric fields in said electro-optic effect layer.

Optionally, a number of electric fields generated by the electrode layer equals a number of sub-pixels of the display panel, each electric field corresponding to one sub-pixel.

Optionally, the sub-pixels in each row of the display panel display a same color; a number of the electric field equals a number of rows of the sub-pixels, each electric field corresponding to one row of sub-pixels.

Optionally, the electric fields corresponding to multiple sub-pixels of one same color in the display panel have a consistent intensity.

Optionally, said electrode layer generates one electric field in said electro-optic effect layer, and said electro-optic effect layer is wholly situated in said electric field.

Optionally, said electrode layer comprises a first electrode positioned on one side of the electro-optic effect layer and a plurality of second electrodes positioned on the other side of the electro-optic effect layer, wherein a number of the second electrodes equals a number of the sub-pixels, and each second electrode corresponds to one sub-pixel.

Optionally, said electrode layer is situated on one side of the electro-optic effect layer, and comprises a plurality of electrode units composed of at least one first electrode and at least one second electrode, wherein a number of the electrode units equals a number of the sub-pixels, and each electrode unit corresponds to one sub-pixel; the first electrode and the second electrode are in a strip form, and the first electrode and the second electrode within each electrode unit are arranged alternately in a region corresponding to a sub-pixel that corresponds to the electrode unit.

Optionally, said electrode layer comprises a first electrode positioned on one side of the electro-optic effect layer, and a plurality of second electrodes positioned on the other side of the electro-optic effect layer, wherein a number of the second electrodes corresponds to a number of rows of the sub-pixels, and each second electrode corresponds to one row of sub-pixels.

Optionally, said electrode layer is situated on one side of the electro-optic effect layer, and comprises a plurality of electrode units composed of at least one first electrode and at least one second electrode, wherein a number of the electrode units equals a number of rows of the sub-pixels, and each electrode unit corresponds to one row of sub-pixels; the first electrode and the second electrode are in a strip form, and the first electrode and the second electrode within each electrode unit are arranged alternately in a region corresponding to a row of sub-pixels that corresponds to the electrode unit.

Optionally, said electrode layer comprises a first electrode and a second electrode disposed on respective sides of the electro-optic effect layer, wherein the first electrode and the second electrode are in a plate form, and the projections of the first electrode and the second electrode on the electro-optic effect layer correspond to the electro-optic effect layer.

Optionally, said electrode layer comprises a plurality of first electrodes and a plurality of second electrodes disposed on one side of the electro-optic effect layer, wherein the first electrodes and the second electrodes are in a strip form, and the first electrodes and the second electrodes are arranged alternately.

As a further technical solution, this disclosure further provides a display device, comprising the above display panel provided in this disclosure.

This disclosure has the following beneficial effects:

The display panel provided in this disclosure causes the birefringence of light rays to occur when they pass through an electro-optic effect layer by controlling the intensity of one or more electric fields generated by an electrode layer in the electro-optic effect layer, and thereby controls the transmittance of the light rays when they pass through the electro-optic effect layer, i.e., it controls a luminance range capable of being displayed by each sub-pixel, and adjusts the color gamut displayed by each pixel unit so as to achieve the adjustment of the color gamut displayed by the display panel. As compared with the technical solutions of adjusting the color gamut displayed by a display panel in the prior art, the display panel provided in this disclosure is capable of flexibly adjusting the color gamut displayed by the display panel within a larger range and has a lower cost.

### BRIEF DESCRIPTION OF DRAWINGS

The drawings aim to provide further understandings of this disclosure. They constitute a part of the description for construing this disclosure together with the following embodiments, but they do not limit this disclosure. In the drawings:

FIG. 1 is a schematic view of a first embodiment of the display panel provided in this disclosure;

FIG. 2 is a schematic view of a film layer made of a crystal material having Kerr effect as an electro-optic effect layer;

FIG. 3 is a schematic view of a first structure of the electrode layer;

FIG. 4 is a schematic view of a second structure of the electrode layer;

FIG. 5 is a schematic view of a third structure of the electrode layer;

FIG. 6 is a schematic view of a fourth structure of the electrode layer;

FIG. 7 is a schematic view of a fifth structure of the electrode layer;

FIG. 8 is a schematic view of a sixth structure of the electrode layer;

FIG. 9 is a schematic view of a second embodiment of the display panel provided in this disclosure.

### EXPLANATIONS OF REFERENCE SIGNS

1 display panel; 10: array substrate; 11: color film substrate; 12: first liquid crystal layer; 13: electro-optic effect layer; 14: electrode layer; 15: polarizer; 16: first substrate; 17: second liquid crystal layer; 18: first electrode; 19: second electrode.

### DETAILED DESCRIPTION OF EMBODIMENTS

Detailed description shall be provided for the embodiments of this disclosure in the following text with reference to the drawings. It should be understood that the embodiments described herein are used only for describing and explaining this disclosure, instead of limiting this disclosure.

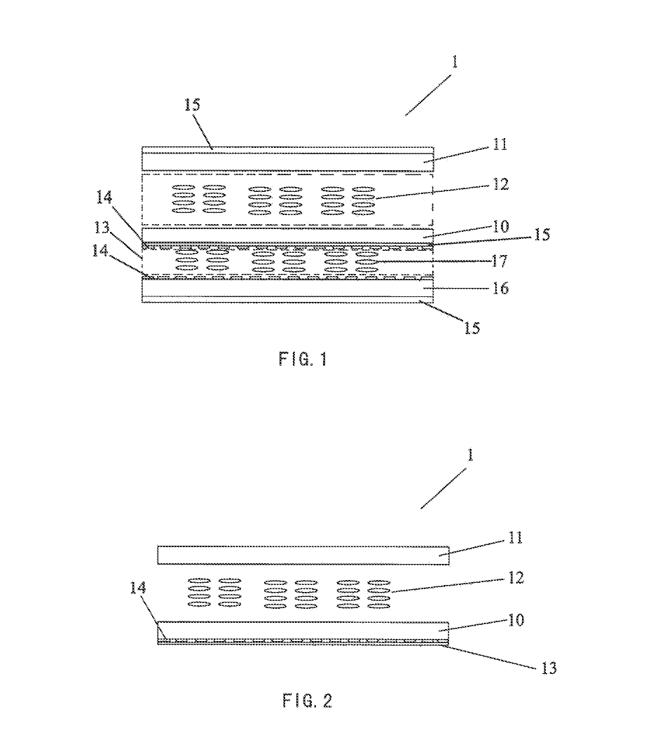

Referring to FIG. 1, FIG. 1 is a schematic view of a first embodiment of the display panel provided in this disclosure. In this embodiment, a display panel 1 comprises an array substrate 10, a color film substrate 11, a first liquid crystal layer 12 disposed between the array substrate 10 and the color film substrate 11, an electro-optic effect layer 13 and an electrode layer 14. The electrode layer 14 is used to generate an electric field in the electro-optic effect layer 13, and it can be arranged on both sides of the electro-optic effect layer 13 as shown in FIG. 1, or on one side of the electro-optic effect layer 13 as shown in FIG. 2; the electro-optic effect layer 13 is arranged on an outer side of the array substrate 10 for causing the birefringence of light rays to occur under the effect of said electric field when they pass through the electro-optic effect layer 13. In this embodiment, polarizers 15 are arranged respectively on an outer side of the electro-optic effect layer 13, on an outer side of the array substrate 10 and on an outer side of the color film substrate 11.

Specifically, when light rays pass through the electro-optic effect layer 13 in the electric field and the birefringence of the light rays occurs, a phase delay will occur, and since the light rays are polarized, the transmittance of the light rays in the electro-optic effect layer 13 will be affected. It can be understood that the intensity of the electric field determines the birefringence of light rays in the electro-optic effect layer 13, and determines the transmittance of light rays in the electro-optic effect layer 13. Therefore, in this embodiment, depending on the intensity of the electric field generated in the electro-optic effect layer 13, the intensity of light rays impinging on each sub-pixel can be controlled, i.e., a luminance range capable of being displayed by each sub-pixel can be controlled. It can be understood that when the luminance range capable of being displayed by each sub-pixel changes, in the colors displayed by each pixel unit of the display panel 1, the stimulus value of the color displayed by each sub-pixel comprised in the pixel unit changes accordingly, thereby causing the color gamut displayed by each pixel unit of the display panel 1 to change accordingly. That is, the color gamut displayed by the display panel 1 is changed.

In this embodiment, as shown in FIG. 1, the display panel 1 further comprises a first substrate 16 disposed on an outer side of the array substrate 10; the electro-optic effect layer 13 is a second liquid crystal layer 17 arranged between the array substrate 10 and the first substrate 16. It can be easily understood that under the effect of the electric field, liquid crystal molecules in the second liquid crystal layer 17 will be deflected. With different deflection angles of the liquid crystal molecules, the light rays have correspondingly different transmittances in the second liquid crystal layer 17, thereby enabling the electro-optic effect layer 13 to change the intensity of light rays impinging on each sub-pixel.

In addition to the above example in which the electro-optic effect layer 13 is the second liquid crystal layer 17, the electro-optic effect layer 13 may further be a film layer made of a crystal material having Kerr effect as shown in FIG. 2. Specifically, the crystal material having Kerr effect includes at least one of nitrobenzene and nitrotoluene. In light of the Kerr electro-optic effect, when the light rays pass through the above crystal material in an electric field, birefringence will occur, thereby enabling the electro-optic effect layer 13 to change the intensity of light rays impinging on each sub-pixel.

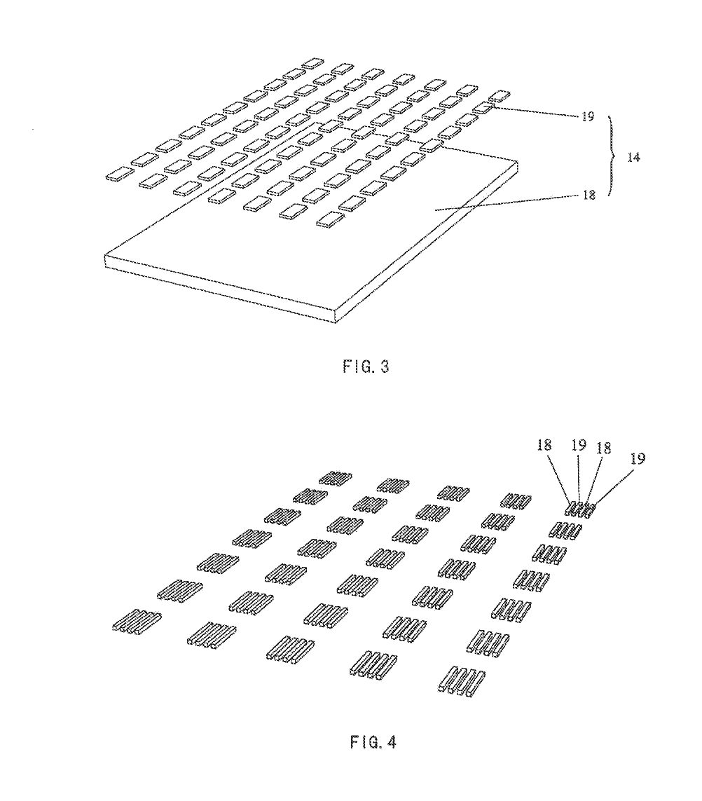

In this embodiment, as show in FIG. 3, the electrode layer 14 may comprise a first electrode 18 positioned on one side of the electro-optic effect layer 13 and a plurality of second electrodes 19 positioned on the other side of the electro-optic effect layer 13, wherein a number of the second electrodes 19 equals a number of the sub-pixels, and each second electrode 19 corresponds to one sub-pixel. In this example, one or more electric fields can be generated in the electro-optic effect layer 13 by applying corresponding voltages to the first electrode 18 and the second electrodes 19 respectively.

Specifically, a plurality of electric fields can be generated in the electro-optic effect layer 13 when a voltage is applied to the first electrode 18 and corresponding voltages are applied to the plurality of second electrodes 19 respectively, wherein a number of the electric fields equals a number of the sub-pixels, and each sub-pixel corresponds to one electric field; in this case, through control of the intensity of each electric field, the luminance range capable of being displayed by a sub-pixel corresponding to the electric field can be adjusted. Furthermore, through control of the luminance range capable of being displayed by a plurality of sub-pixels comprised in each pixel unit, the color gamut displayed by said pixel unit can be adjusted independently. Thus the adjustment of color gamut displayed by the display panel 1 can be achieved by adjusting the color gamuts displayed by a plurality of pixel units.

Optionally, in this example, a same voltage is provided to the plurality of second electrodes 19 corresponding to all sub-pixels displaying one same color. By doing this, a plurality of electric fields can be generated in the electro-optic effect layer 13, each electric field corresponding to sub-pixels of one color; in this case, through control of the intensity of each electric field, the luminance range capable of being displayed by sub-pixels of one color corresponding to the electric field can be adjusted, and furthermore, through control of the luminance range capable of being displayed by sub-pixels of different colors, the color gamuts displayed by all pixel units of the display panel 1, i.e., the color gamut displayed by the display panel 1, can be adjusted. As the sub-pixels of the display panel 1 displaying one same color will not congregate together, in this optional solution, an electric field may be segmented by other electric fields. However, it should be pointed out that the electric field intensities of the segments of the electric field are consistent. Of course, this does not mean that the intensities of any two electric fields cannot be equal. Specifically, assuming each pixel unit comprises sub-pixels of three colors, namely R pixel displaying red, G pixel displaying green and B pixel displaying blue, three electric fields will be generated in the electro-optic effect layer 13, i.e., a first electric field corresponding to all R pixels, a second electric field corresponding to all G pixels, and a third electric field corresponding to all B pixels (the intensities of the first electric field, the second electric field and the third electric field can be either equal or not); in this case, through respective control of the intensities of the first electric field, the second electric field and the third electric field, the luminance capable of being displayed by all R pixels, all G pixels and all B pixels can be adjusted, and thereby the color gamut displayed by each pixel unit, i.e., the color gamut displayed by the display panel 1, can be determined.

Further optionally, in this example, the voltages provided to all second electrodes 19 are the same such that one electric field can be generated in the electro-optic effect layer 13 and the electro-optic effect layer 13 is wholly situated in said electric field. In this case, through control of the intensity of said electric field, the luminance range capable of being displayed by all sub-pixels can be adjusted, and the color gamut displayed by all pixel units of the display panel 1, i.e., the color gamut displayed by the display panel 1, can be adjusted.

In this embodiment, in addition to the example in which the electrode layer 14 comprises a first electrode 18 and second electrodes 19 positioned on respective sides of the electro-optic effect layer 13 as shown in FIG. 3, the electrode layer 14 can further be situated only on one side of the electro-optic effect layer 13 as shown in FIG. 4, In this case, it comprises a plurality of electrode units composed of at least one first electrode 18 and at least one second electrode 19, wherein a number of the electrode units equals a number of the sub-pixels, and each electrode unit corresponds to one sub-pixel; the first electrode 18 and the second electrode 19 are in a strip form, and the first electrode 18 and the second electrode 19 within each electrode unit are arranged alternately in a region corresponding to a sub-pixel that corresponds to the electrode unit. In the example as shown in FIG. 4, one or more electric fields can be generated in the electro-optic effect layer 13 by applying corresponding voltages to the first electrode 18 and the second electrode 19 within each electrode unit respectively.

Specifically, similar to the example as shown in FIG. 3, when a voltage is applied to each electrode unit independently, a plurality of electric fields can be generated, and each sub-pixel corresponds to one electric field; when a same voltage is provided to electrode units corresponding to all sub-pixels of one same color, a plurality of electric fields can be generated, each electric field corresponding to all sub-pixels displaying one same color; when a same voltage is provided to all electrode units, one electric field can be generated, in which the electro-optic effect layer 13 is wholly situated; in the above three situations, the specific principle of adjusting the color gamut displayed by the display panel 1 through control of the intensity of the electric field(s) has been expounded in the above example as shown in FIG. 3, so no more details shall be given here for simplicity.

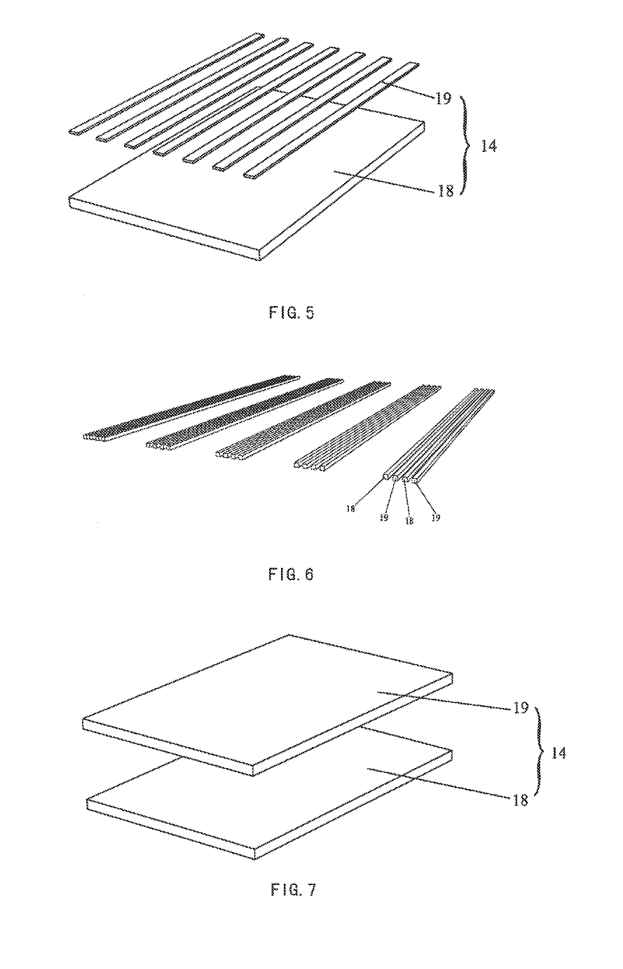

In this embodiment, apart from the examples as shown in FIGS. 3&4, when sub-pixels in each row of the display panel 1 display a same color, as shown in FIG. 5, the electrode layer 14 may further comprise a first electrode 18 positioned on one side of the electro-optic effect layer 13, and a plurality of second electrodes 19 positioned on the other side of the electro-optic effect layer 13, and a number of the second electrodes 19 corresponds to a number of rows of the sub-pixels, wherein each second electrode 19 corresponds to one row of sub-pixels. Therein, the so-called “row” can be either in a direction of a data line of the display panel 1, or in a direction of a gate line of the display panel 1. In this example, by applying corresponding voltages respectively to the first electrode 18 and second electrodes 19, one or more electric fields can be generated in the electro-optic effect layer 13. Besides, since each second electrode 19 corresponds to one row of sub-pixels, it can be known in combination with FIG. 3 and FIG. 5 that the structure of the electrode layer 14 in this example is much simpler, so the manufacture process thereof is less difficult.

Specifically, a plurality of electric fields can be generated in the electro-optic effect layer 13 when a voltage is applied to the first electrode 18 and corresponding voltages are applied to the plurality of second electrodes 19 independently and respectively, wherein a number of the electric fields equals a number of rows of the sub-pixels, and each row of sub-pixels corresponds to one electric field; in this case, through control of the intensity of each electric field, the luminance range capable of being displayed by a row of sub-pixels corresponding to the electric field can be adjusted. Furthermore, through control of the luminance range capable of being displayed by a plurality of sub-pixels comprised in each pixel unit, the color gamut displayed by each row of said pixel units can be adjusted independently. Thus the adjustment of color gamut displayed by the display panel 1 can be achieved by adjusting the color gamuts displayed by multiple rows of pixel units.

Optionally, in this example, a same voltage is provided to the plurality of second electrodes corresponding to all sub-pixels displaying one same color (in other words, the voltages applied to multiple rows of sub-pixels displaying one same color are the same), By doing this, each electric field can correspond to multiple rows of sub-pixels displaying one same color. Thereby, through control of the intensity of each electric field, the luminance range capable of being displayed by multiple rows of sub-pixels displaying one same color (all sub-pixels displaying the color) corresponding to the electric field can be adjusted, and furthermore, through control of the luminance range capable of being displayed by sub-pixels of different colors, the color gamuts displayed by all pixel units of the display panel 1, i.e., the color gamut displayed by the display panel 1, can be adjusted.

Further optionally, in this example, a same voltage can be applied to all second electrodes 19 such that one electric field can be generated in the electro-optic effect layer 13, and the electro-optic effect layer 13 is wholly situated in the electric field. In this case, the principle of adjusting the color gamut displayed by the display panel 1 through control of the intensity of the electric field has been expounded in the above example as shown in FIG. 3, so no more details shall be given here for simplicity.

In this embodiment, apart from the examples as shown in FIGS. 3, 4 and 5, the electrode layer 14 may further comprise a plurality of electrode units composed of at least one first electrode 18 and at least one second electrode 19 as shown in FIG. 6, wherein a number of the electrode units corresponds to a number of rows of the sub-pixels, and each electrode unit corresponds to one row of sub-pixels; the first electrode 18 and the second electrode 19 are in a strip form, and the first electrode and the second electrode within each electrode unit are arranged alternately in a region corresponding to a row of sub-pixels that corresponds to the electrode unit. In the example as shown in FIG. 6, one or more electric fields can be generated in the electro-optic effect layer 13 by applying corresponding voltages respectively to the first electrode 18 and the second electrode 19 within each electrode unit.

Specifically, when a voltage is applied to each electrode unit individually, a plurality of electric fields can be generated, each row of sub-pixels corresponding to one electric field; when a same voltage is applied to electrode units corresponding to multiple rows of sub-pixels of one same color (all sub-pixels displaying one color), a plurality of electric fields can be generated, each electric field corresponding to all sub-pixels displaying one same color; when a same voltage is applied to all electrode units, one electric field can be generated, in which the electro-optic effect layer 13 is wholly situated. In the above three situations, the principle of adjusting the color gamut displayed by the display panel 1 through control of the intensity of the electric field(s) has been expounded in the above example as shown in FIG. 3, so no more details shall be given here for simplicity.

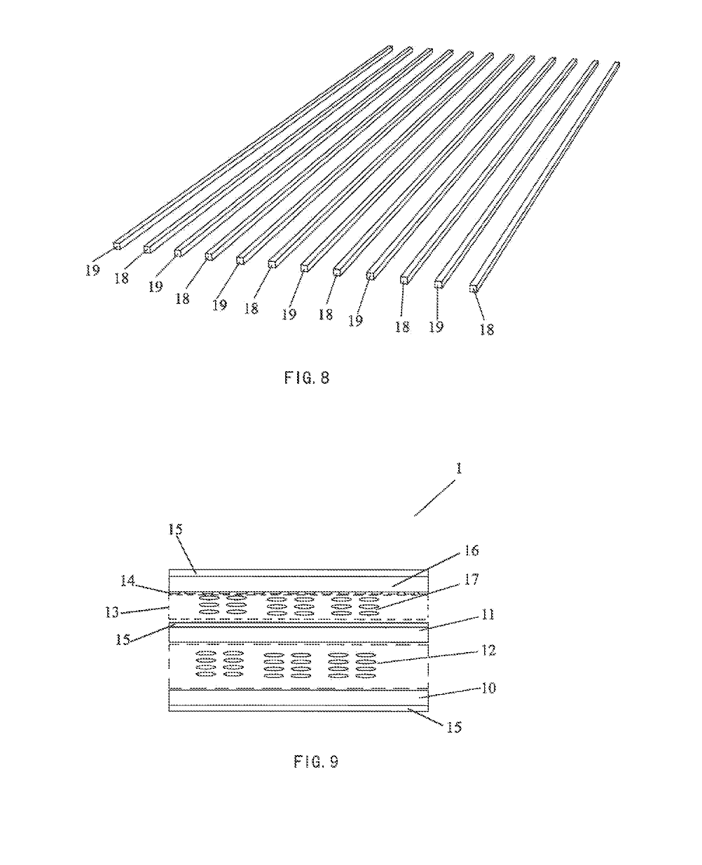

In this embodiment, apart from the examples as shown in FIGS. 3-6, the electrode layer 14 may further comprise a first electrode 18 and a second electrode 19 disposed on respective sides of the electro-optic effect layer 13 as shown in FIG. 7, wherein the first electrode 18 and the second electrode 19 are in a plate form, and the projections of the first electrode 18 and the second electrode 19 on the electro-optic effect layer 13 correspond to the electro-optic effect layer 13. In this example, by applying corresponding voltages to the first electrode 18 and the second electrode 19 respectively, one electric field can be generated in the electro-optic effect layer 13, and the electro-optic effect layer 13 is wholly situated in said electric field. In this case, the principle of adjusting the color gamut displayed by the display panel 1 through control of the intensity of the electric field has been expounded in the above example as shown in FIG. 3, so no more details shall be given here for simplicity.

In this embodiment, apart from the examples as shown in FIGS. 3-7, the electrode layer 14 may further comprise a plurality of first electrodes 18 and a plurality of second electrodes 19 disposed merely on one side of the electro-optic effect layer 13 as shown in FIG. 8, wherein the first electrodes 18 and the second electrodes 19 are in a plate form, and the first electrodes 18 and the second electrodes 19 are arranged alternately. In this example, by applying corresponding voltages to the first electrodes 18 and the second electrodes 19 respectively, one electric field can be generated in the electro-optic effect layer 13, and the electro-optic effect layer 13 is wholly situated in said electric field. In this case, the principle of adjusting the color gamut displayed by the display panel 1 through control of the intensity of the electric field has been expounded in the above example as shown in FIG. 3, so no more details shall be given here for simplicity.

Referring to FIG. 9, FIG. 9 is schematic view of a second embodiment of the display panel provided in this disclosure. In this embodiment, the display panel 1 also comprises an array substrate 10, a color film substrate 11, a first liquid crystal layer 12 disposed between the array substrate 10 and the color film substrate 11, an electro-optic effect layer 13 and an electrode layer 14. As detailed descriptions have been provided in the above first embodiment, no more details about the similarities between this embodiment and the above first embodiment shall be given here for simplicity.

Only the differences between the second embodiment of the display panel of this disclosure and the above first embodiment shall be expounded in the following text. In this embodiment, the electro-optic effect layer 13 is disposed on an outer side of the color film substrate 11. Specifically, when the electro-optic effect layer 13 is a film layer made of a crystal material having Kerr effect, the film layer is constructed on an outer side of the color film substrate 11; when the electro-optic effect layer is a second liquid crystal layer 17, the display panel 1 further comprises a first substrate 16 disposed on an outer side of the color film substrate 11, and the second liquid crystal layer 17 is disposed between the color film substrate 11 and the first substrate 16. In this embodiment, polarizers 15 are arranged respectively on an outer side of the array substrate 10, on an outer side of the color film substrate 11 and on an outer side of the electro-optic effect layer 13.

In this embodiment, light rays emitted from the backlight sources sequentially impinge on the array substrate 10, the first liquid crystal layer 12, the color film substrate 11 of the display panel 1, and finally shoot out via the electro-optic effect layer 13. When a voltage is provided to the electrode layer 14 to generate one or more electric fields in the electro-optic effect layer 13, the transmittance of the light rays emitted from each sub-pixel in the electro-optic effect layer 13 can be controlled depending on the intensity of the electric field(s), and the luminance displayed by each sub-pixel in each pixel unit viewed by a viewer can be controlled. It can be understood that when the intensity of electric field(s) changes, the transmittance of the light rays emitted from each sub-pixel in the electro-optic effect layer 13 changes accordingly, such that in the colors displayed by each pixel unit viewed by the viewer, the stimulus value of the color displayed by each sub-pixel comprised in the pixel unit changes accordingly. That is, the color gamut displayed by each pixel unit and the color gamut displayed by the display panel 1 change.

To sum up, this disclosure provides a display panel 1, which causes corresponding birefringence of light rays to occur when they pass through an electro-optic effect layer 13 by controlling an electrode layer 14 to generate one or more electric fields in the electro-optic effect layer 13, and thereby controls the transmittance of the light rays when they pass through the electro-optic effect layer 13, i.e., it controls a luminance range capable of being displayed by each sub-pixel, and adjusts the color gamut displayed by each pixel unit so as to achieve the adjustment of the color gamut displayed by the display panel 1. As compared with the technical solutions of adjusting the color gamut displayed by a display panel in the prior art, the display panel 1 provided in this disclosure is capable of adjusting the color gamut displayed by the display panel 1 in a larger continuous range. Besides, said adjustment is not limited to united adjustment of the luminance of light rays passing through each sub-pixel, but instead, the luminance of light rays passing through sub-pixels of different colors can be adjusted respectively and even light rays passing through each pixel can be adjusted independently, which makes the adjustment of color gamut of the display panel 1 provided in this disclosure more flexible. In addition, in this disclosure, no extra backlight sources are needed, and as a result the display panel 1 can be made at a lower cost.

This disclosure further provides a display device, and the display device comprises a display panel provided according to the above embodiments of the display panel in this disclosure.

The display device provided in this disclosure is capable of flexibly adjusting the color gamut it displays within a larger range and has a lower cost.

It can be understand that the above embodiments are only exemplary embodiments for explaining the principles of this disclosure, and this disclosure is not limited thereto. For an ordinary person skilled in the art, various modifications and improvements can be made without deviating from the spirit and the essence of this disclosure, and these modifications and improvements should also be deemed as falling within the protection scope of this disclosure.

1. A display panel, comprising an array substrate, a color film substrate and a first liquid crystal layer disposed between the array substrate and the color film substrate, wherein said display panel further comprises an electro-optic effect layer and an electrode layer disposed on one side or on both sides of the electro-optic effect layer;
said electrode layer is used to generate an electric field in said electro-optic effect layer;
said electro-optic effect layer is disposed on an outer side of the array substrate or on an outer side of the color film substrate, for causing the birefringence of light rays to occur under the effect of said electric field when they pass through said electro-optic effect layer.

2. The display panel according to claim 1, wherein said electro-optic effect layer is a film layer made of a crystal material having Kerr effect.

3. The display panel according to claim 2, wherein the crystal material having Kerr effect includes at least one of nitrobenzene and nitrotoluene.

4. The display panel according to claim 1, wherein said display panel further comprises a first substrate disposed at an outer side of the array substrate, and said electro-optic effect layer is a second liquid crystal layer disposed between the array substrate and the first substrate disposed at an outer side of the array substrate.

5. The display panel according to claim 1, wherein said display panel further comprises a first substrate disposed at an outer side of the color film substrate, and said electro-optic effect layer is a second liquid crystal layer disposed between the color film substrate and the first substrate disposed on an outer side of the color film substrate.

6. The display panel according to claim 1, wherein said electrode layer generates a plurality of electric fields in said electro-optic effect layer.

7. The display panel according to claim 6, wherein a number of electric fields generated by the electrode layer equals a number of sub-pixels of the display panel, each electric field corresponding to one sub-pixel.

8. The display panel according to claim 6, wherein the sub-pixels in each row of the display panel display a same color;
a number of the electric field equals a number of rows of the sub-pixels, each electric field corresponding to one row of sub-pixels.

9. The display panel according to claim 7, wherein the electric fields corresponding to multiple sub-pixels of one same color in the display panel have a consistent intensity.

10. The display panel according to claim 1, wherein said electrode layer generates one electric field in said electro-optic effect layer, wherein said electro-optic effect layer is wholly situated in said electric field.

11. The display panel according to claim 7, wherein said electrode layer comprises a first electrode positioned on one side of the electro-optic effect layer and a plurality of second electrodes positioned on the other side of the electro-optic effect layer, wherein a number of the second electrodes equals a number of the sub-pixels, each second electrode corresponding to one sub-pixel.

12. The display panel according to claim 7, wherein said electrode layer is situated on one side of the electro-optic effect layer, and comprises a plurality of electrode units composed of at least one first electrode and at least one second electrode, wherein a number of the electrode units equals a number of the sub-pixels, each electrode unit corresponding to one sub-pixel.

13. The display panel according to claim 12, wherein the first electrode and the second electrode are in a strip form, and the first electrode and the second electrode within each electrode unit are arranged alternately in a region corresponding to a sub-pixel that corresponds to the electrode unit.

14. The display panel according to claim 8, wherein said electrode layer comprises a first electrode positioned on one side of the electro-optic effect layer, and a plurality of second electrodes positioned on the other side of the electro-optic effect layer, wherein a number of the second electrodes corresponds to a number of rows of the sub-pixels, each second electrode corresponding to one row of sub-pixels.

15. The display panel according to claim 8, wherein said electrode layer is situated on one side of the electro-optic effect layer, and comprises a plurality of electrode units composed of at least one first electrode and at least one second electrode, wherein a number of the electrode units equals a number of rows of the sub-pixels, each electrode unit corresponding to one sub-pixel.

16. The display panel according to claim 15, wherein the first electrode and the second electrode are in a strip form, and the first electrode and the second electrode within each electrode unit are arranged alternately in a region corresponding to a row of sub-pixels that corresponds to the electrode unit.

17. The display panel according to claim 10, wherein said electrode layer comprises a first electrode and a second electrode disposed on respective sides of the electro-optic effect layer, wherein the first electrode and the second electrode are in a plate form, the projections of the first electrode and the second electrode on the electro-optic effect layer corresponding to the electro-optic effect layer.

18. The display panel according to claim 10, wherein said electrode layer comprises a plurality of first electrodes and a plurality of second electrodes disposed on one side of the electro-optic effect layer, wherein the first electrodes and the second electrodes are in a strip form, and wherein the first electrodes and the second electrodes are arranged alternately.

19. A display device comprising a display panel according to claim 1.
